(19) United States
(12) Patent Application Publication
(10) Pub. No.: US 2024/0267690 A1
(43) Pub. Date: Aug. 8, 2024

(54) AUDIO RENDERING SYSTEM AND METHOD

(71) Applicant: Beijing Zitiao Network Technology Co., Ltd., Beijing (CN)

(72) Inventors: Xuzhou YE, Beijing (CN); Chuanzeng HUANG, Beijing (CN); Junjie SHI, Beijing (CN); Zhengpu ZHANG, Beijing (CN); Derong LIU, Beijing (CN)

(21) Appl. No.: 18/622,805

(22) Filed: Mar. 29, 2024

Related U.S. Application Data
(63) Continuation of application No. PCT/CN2022/122635, filed on Sep. 29, 2022.

(30) Foreign Application Priority Data
Sep. 29, 2021 (WO) PCT/CN2021/121718

(51) Int. Cl. H04S 7/00; G06T 17/00

(52) U.S. Cl. CPC H04S 7/30; G06T 17/00; G06T 2210/12; H04S 2420/03

(57) ABSTRACT

The present disclosure relates to an audio rendering method, comprising obtaining audio metadata, the audio metadata including acoustic environment information; setting parameters for audio rendering according to the acoustic environment information, the parameters for audio rendering including acoustic information of an approximately rectangular parallelepiped room scene; and rendering an audio signal according to the parameters for audio rendering.

### CROSS-REFERENCE TO RELATED APPLICATIONS

This application is a continuation of International Application No. PCT/CN2022/122635, filed on Sep. 29, 2022, which claims priority to International Application No. PCT/CN2021/121718, filed on Sep. 29, 2021. The entire contents of these applications are hereby incorporated by reference in their entireties.

### TECHNICAL FIELD

The present disclosure relates to an audio rendering system and method, and more specifically to a system and method for estimating acoustic information of an approximately rectangular parallelepiped room scene.

### BACKGROUND

All sounds in the real world are spatial audio. Sound originates from the vibration of objects, propagates through media, and is heard by us. In the real world, a vibrating object can appear anywhere, and the vibrating object and a person's head will form a three-dimensional direction vector. Since the human body receives sound through both ears, the horizontal angle of the direction vector will affect the loudness difference, time difference and phase difference of the sound reaching our ears; the vertical angle of the direction vector will also affect the frequency response of the sound reaching our ears. It is precisely by relying on this physical information that we humans have acquired the ability to determine the location of a sound source according to binaural sound signals through a large amount of acquired unconscious training.

### SUMMARY

In some embodiments of the present disclosure, an audio rendering method is disclosed, comprising obtaining audio metadata, the audio metadata including acoustic environment information; setting parameters for audio rendering according to the acoustic environment information, the parameters for audio rendering including acoustic information of an approximately rectangular parallelepiped room scene; and rendering an audio signal according to the parameters for audio rendering.

In some embodiments, the rectangular parallelepiped room includes a cube room.

In some embodiments, rendering the audio signal according to the parameters for audio rendering includes: spatially encoding the audio signal based on the parameters for audio rendering, and spatially decoding the spatially encoded audio signal to obtain a decoded audio-rendered audio signal.

In some embodiments, the audio signal includes a spatial audio signal.

In some embodiments, the spatial audio signal includes at least one of: an object-based spatial audio signal, a scene-based spatial audio signal, and a channel-based spatial audio signal.

In some embodiments, the acoustic information of the approximately rectangular parallelepiped room scene includes at least one of: the size of the room, center coordinates of the room, orientation, and approximate acoustic properties of the wall material.

In some embodiments, the acoustic environment information includes a scene point cloud consisting of a plurality of scene points collected from a virtual scene.

In some embodiments, collecting a scene point cloud consisting of a plurality of scene points from a virtual scene includes setting N intersection points of N rays emitted in various directions with a listener as the origin and the scene as scene points.

In some embodiments, estimating the acoustic information of the approximately rectangular parallelepiped room scene according to scene point clouds collected from the virtual scene includes: determining a minimum bounding box according to the collected scene point clouds; and determining the estimated size and center coordinates of the rectangular parallelepiped room scene according to the minimum bounding box.

In some embodiments, determining the minimum bounding box includes determining the average position of the scene point clouds; converting position coordinates of the scene point clouds to the room coordinate system according to the average position; grouping the scene point clouds converted to the room coordinate system according to the scene point clouds and the average position of the scene point clouds, where each group of scene point clouds corresponds to one wall of a house; and, for each group, determining a separation distance between a wall corresponding to a grouped scene point cloud and the average position of the scene point clouds as the minimum bounding box.

In some embodiments, determining a separation distance between a wall corresponding to a grouped scene point cloud and the average position of the scene point clouds includes determining a projection length of the distance from a scene point cloud converted to the room coordinate system to the coordinate origin being projected to a wall referred to by the group; and determining the maximum value of all projection lengths of the current group as the separation distance between the wall corresponding to the grouped scene point cloud and the average position.

In some embodiments, determining a separation distance between a wall corresponding to the grouped scene point cloud and the average position of the scene point clouds includes determining the separation distance when the group is not empty; and determining that the wall is missing when the group is empty.

In some embodiments, the acoustic information of the approximately rectangular parallelepiped room scene includes approximate acoustic information of the room wall material, and estimating acoustic information of approximately rectangular parallelepiped room scene according to scene point clouds collected from a virtual scene further includes: determining approximate acoustic properties of the material of the wall referred to by the group according to the average absorptance, average scattering rate, and average transmittance of all point clouds in the group.

In some embodiments, the acoustic information of the approximately rectangular parallelepiped room scene includes the orientation of a room, and estimating acoustic information of the approximately rectangular parallelepiped room scene according to scene point clouds collected from a virtual scene further includes: determining the orientation of the approximately rectangular parallelepiped room according to the average normal vector of all point clouds in the group and the angle with the normal vector of the wall referred to by the group.

In some embodiments, the method further comprises estimating acoustic information of an approximately rectangular parallelepiped room scene frame by frame according to scene point clouds collected from a virtual scene, including determining the minimum bounding box according to scene point clouds collected in the current frame and scene point clouds collected in previous frames; and determining the size and center coordinates of the rectangular parallelepiped room scene estimated in the current frame according to the minimum bounding box.

In some embodiments, the number of the previous frames is determined according to properties estimated from acoustic information of the approximately rectangular parallelepiped room scene.

In some embodiments, determining the minimum bounding box according to scene point clouds collected in the current frame and scene point clouds collected in previous frames includes determining the average position of the scene point clouds of the current frame; converting position coordinates of the scene point clouds to the room coordinate system according to the average position and the orientation of an approximately rectangular parallelepiped room estimated in the previous frame; grouping the scene point clouds converted to the room coordinate system according to the size of the approximately rectangular parallelepiped room estimated in the previous frame, where each group of scene point clouds corresponds to one wall of a house; for each group, determining a separation distance between a wall corresponding to a grouped scene point cloud and the average position of the scene point clouds; and from 1) the separation distance of the current frame and 2) the difference between separation distances of multiple previous frames and the product of the room orientation change and the average position change, determining the maximum value as the minimum bounding box of the current frame.

In some embodiments, the minimum bounding box is determined from the collected scene point clouds based on the following equation:

$$m c d ( w ) = {max}_{t = 0 : ( h ( w ) - 1 )} ( w c d ( - t ) ( w ) - ( r o t ( 0 ) * r o {t ( - t )}^{- 1} ) * ( \overline{p} ( 0 ) - \overline{p} ( - t ) ) )$$

where mcd(w) represents the distance from each wall w to the current p̅ in the minimum bounding box to be solved; rot(t) represents orientation information of the approximately rectangular parallelepiped room in the t-th frame; and p̅(t) represents the average position of the scene point clouds in the t-th frame.

In some embodiments of the present disclosure, an audio rendering system is disclosed, comprising an audio metadata module configured to obtain acoustic environment information; wherein the audio metadata module is configured to set parameters for audio rendering according to the acoustic environment information, the parameters for audio rendering including acoustic information of an approximately rectangular parallelepiped room scene, the parameters for audio rendering being used to render an audio signal.

In some embodiments, the rectangular parallelepiped room includes a cube room.

In some embodiments, the system further includes a spatial encoding module configured to spatially encode the audio signal based on parameters for audio rendering; and a spatial decoding module configured to spatially decode the spatially encoded audio signal to obtain the decoded audio-rendered audio signal.

In some embodiments, the audio signal includes a spatial audio signal.

In some embodiments, the spatial audio signal includes at least one of: an object-based spatial audio signal, a scene-based spatial audio signal, and a channel-based spatial audio signal.

In some embodiments, the acoustic information of the approximately rectangular parallelepiped room scene includes at least one of: size, center coordinates, orientation, and approximate acoustic properties of the wall material.

In some embodiments, the acoustic environment information includes a scene point cloud consisting of a plurality of scene points collected from a virtual scene.

In some embodiments, collecting a scene point cloud consisting of a plurality of scene points from a virtual scene includes setting N intersection points of N rays emitted in various directions with a listener as the origin and the scene as scene points.

In some embodiments, estimating the acoustic information of the approximately rectangular parallelepiped room scene according to scene point clouds collected from the virtual scene includes: determining a minimum bounding box according to the collected scene point clouds; and determining the estimated size and center coordinates of the rectangular parallelepiped room scene according to the minimum bounding box.

In some embodiments, determining the minimum bounding box includes determining the average position of the scene point clouds; converting position coordinates of the scene point clouds to the room coordinate system according to the average position; grouping the scene point clouds converted to the room coordinate system according to the scene point clouds and the average position of the scene point clouds, where each group of scene point clouds corresponds to one wall of a house; and, for each group, determining a separation distance between a wall corresponding to a grouped scene point cloud and the average position of the scene point clouds as a minimum bounding box.

In some embodiments, determining a separation distance between a wall corresponding to a grouped scene point cloud and the average position of the scene point clouds includes: determining a projection length of the distance from a scene point cloud converted to the room coordinate system to the coordinate origin being projected to a wall referred to by the group; and determining the maximum value of all projection lengths of the current group as the separation distance between the wall corresponding to the grouped scene point cloud and the average position.

In some embodiments, determining a separation distance between a wall corresponding to the grouped scene point cloud and the average position of the scene point clouds includes: determining the separation distance when the group is not empty; and determining that the wall is missing when the group is empty.

In some embodiments, the acoustic information of the approximately rectangular parallelepiped room scene includes approximate acoustic information of the room wall material, and estimating acoustic information of approximately rectangular parallelepiped room scene according to scene point clouds collected from a virtual scene further includes: determining approximate acoustic properties of the material of the wall referred to by the group according to the average absorptance, average scattering rate, and average transmittance of all point clouds in the group.

In some embodiments, the acoustic information of the approximately rectangular parallelepiped room scene includes the orientation of a room, and estimating acoustic information of the approximately rectangular parallelepiped room scene according to scene point clouds collected from a virtual scene further includes: determining the orientation of the approximately rectangular parallelepiped room according to the average normal vector of all point clouds in the group and the angle with the normal vector of the wall referred to by the group.

In some embodiments, the system further comprises estimating acoustic information of an approximately rectangular parallelepiped room scene frame by frame according to scene point clouds collected from a virtual scene, including determining a minimum bounding box according to scene point clouds collected in the current frame and scene point clouds collected in previous frames; and determining the size and center coordinates of the rectangular parallelepiped room scene estimated in the current frame according to the minimum bounding box.

In some embodiments, the number of the previous frames is determined according to properties estimated from acoustic information of an approximately rectangular parallelepiped room scene.

In some embodiments, determining a minimum bounding box according to scene point clouds collected in the current frame and scene point clouds collected in previous frames includes determining the average position of the scene point clouds of the current frame; converting position coordinates of the scene point clouds to the room coordinate system according to the average position and the orientation of an approximately rectangular parallelepiped room estimated in the previous frame; grouping the scene point clouds converted to the room coordinate system according to the size of the approximately rectangular parallelepiped room estimated in the previous frame, where each group of scene point clouds corresponds to one wall of a house; for each group, determining a separation distance between a wall corresponding to a grouped scene point cloud and the average position of the scene point clouds; and determining the maximum value as the minimum bounding box of the current frame from 1) the separation distance of the current frame and 2) the difference between separation distances of multiple previous frames and the product of the room orientation change and the average position change.

In some embodiments, the minimum bounding box is determined from the collected scene point clouds based on the following equation:

$$m c d ( w ) = {max}_{t = 0 : ( h ( w ) - 1 )} ( w c d ( - t ) ( w ) - ( r o t ( 0 ) * r o {t ( - t )}^{- 1} ) * ( \overline{p} ( 0 ) - \overline{p} ( - t ) ) )$$

where mcd(w) represents the distance from each wall w to the current p̅in the minimum bounding box to be solved; rot(t) represents orientation information of the approximately rectangular parallelepiped room in the t-th frame; and p̅(t) represents the average position of the scene point clouds in the t-th frame.

In some embodiments of the present disclosure, a chip is disclosed, comprising: at least one processor and an interface, the interface being used to provide computer executable instructions to the at least one processor, the at least one processor being used to execute the computer executable instructions to implement the method as described above.

In some embodiments of the present disclosure, an electronic device is disclosed, comprising: a memory; and a processor coupled to the memory, the processor being configured to perform the method described above based on instructions stored in the memory apparatus.

In some embodiments of the present disclosure, a non-transitory computer-readable storage medium is disclosed, which has a computer program stored thereon, which, when executed by a processor, implement the method as described above.

In some embodiments of the present disclosure, a computer program product is disclosed, comprising instructions, which, when executed by a processor, cause the processor to perform the method as described above.

Other features and advantages of the present disclosure will become apparent from the following detailed description of exemplary embodiments of the present disclosure with reference to the accompanying drawings.

### BRIEF DESCRIPTION OF THE DRAWINGS

FIG. 1 is a schematic diagram of an audio rendering system according to some embodiments of the present disclosure;

FIG. 2 is a schematic diagram of an audio rendering system according to some embodiments of the present disclosure;

FIG. 3 is a block diagram of steps for an audio rendering system to set parameters for audio rendering according to some embodiments of the present disclosure;

FIG. 4 is a block diagram of steps for an audio rendering system to set parameters for audio rendering according to some embodiments of the present disclosure;

FIG. 5 is a block diagram of steps for an audio rendering system to set parameters for audio rendering according to other embodiments of the present disclosure;

FIG. 6 is a block diagram of steps for an audio rendering system to set parameters for audio rendering according to other embodiments of the present disclosure;

FIG. 7 shows a schematic diagram of an estimated approximately rectangular parallelepiped room scene;

FIG. 8 shows a schematic diagram of an electronic device according to some embodiments of the present disclosure;

FIG. 9 shows a schematic diagram of the structure of an electronic device according to some embodiments of the present disclosure;

FIG. 10 is a schematic diagram of an audio renderer according to some embodiments of the present disclosure;

FIG. 11 is a schematic diagram of a virtual reality audio content expression framework according to some embodiments of the present disclosure; and

FIG. 12 shows a schematic diagram of a chip capable of implementing some embodiments in accordance with the present disclosure.

### DETAILED DESCRIPTION

In an immersive virtual environment, in order to simulate various information given to people by the real world as much as possible, so as not to break users' immersion, we must also simulate with high quality the impact of sound position on binaural signals we hear.

This effect, when the sound source position and the listener position are determined in a static environment, can be expressed by a head response function (HRTF). HRTF is a two-channel FIR filter; by convolving an original signal with an HRTF at a specified position, we can get the signal we hear when the sound source is at that position.

However, one HRTF can only represent the relative positional relationship between one fixed sound source and one certain listener. When we need to render N sound sources, theoretically we need N HRTFs to perform 2N convolutions on N original signals; and when the listener rotates, we need to update all N HRTFs to correctly render a virtual spatial audio scene. It is very computationally intensive by doing so.
In order to solve the problem of multi-sound source rendering and listener 3DOF rotation, a spherical harmonic function is applied to spatial audio rendering. The basic idea of the spherical harmonic function (ambisonic) is to imagine that the sound is distributed on a spherical surface, and N signal channels pointing in different directions perform their respective duties and are responsible for the sound in corresponding direction. The spatial audio rendering algorithm based on ambisonics is as follows:
1. The sampling points in each ambisonics channel are set to 0;
2. Calculate a weight value of each ambisonics channel by using the horizontal angle and pitch angle of the sound source relative to the listener;
3. Multiply the original signal by the weight value of each ambisonics channel and superimpose it on each channel;
4. Repeat step 3 for all sound sources in the scene;
5. Set all sampling points of a binaural output signal to 0;
6. Convolve each ambisonics channel signal with the HRTF in the corresponding direction of the channel, and superimpose it on the binaural output signal;
Repeat step 6 for all ambisonics channels.

In this way, the number of convolutions is only related to the number of amnisonics channels and is irrelevant to the number of sound sources, but encoding sound sources to ambisonics is much faster than convolution. Not only that, if the listener rotates, all ambisonics channels can be rotated, and the amount of calculation is irrelevant to the number of sound sources as well. In addition to rendering the ambisonics signal to both ears, it can also be simply rendered to a speaker array.

On the other hand, in the real world, the sounds we humans, including other animals, perceive are not only direct sounds from the sound source reaching our ears directly, but also vibration waves from the sound source that reach our ears through environmental reflection, scattering and diffraction. Wherein, environmental reflection and scattered sound directly affect our auditory perception of the sound source and the listener's own environment. This kind of perception is the basic principle by which nocturnal animals such as bats can locate themselves in the dark and understand their environment.

We humans may not be as sensitive as bats in terms of hearing, but we can also gain a lot of information by listening to the impact of the environment on the sound source. Please imagine the following scene: Even we are listening to a singer singing. We can clearly tell whether we are listening to the song in a large church or in a parking lot, because the reverberation time is different; even in a church, we can also clearly tell whether we are listening to the song 1 meter directly in front of the singer, or 20 meters directly in front of the singer, because the proportions of reverberation and direct sound are different. Still in the church, we can clearly tell whether we are listening to the singer singing in the center of the church; or we have one ear to listen to the song only 10 centimeters away from a wall; this is because the loudness of the early reflected sounds is different.

Environmental acoustic phenomena are ubiquitous in reality, so in an immersive virtual environment, in order to simulate various information given to people by the real world as much as possible, so as not to break the users' immersion, we must also simulate with high quality the impact of a virtual scene on the sound in the scene.

There are three main categories of existing methods for simulating environmental acoustic phenomena: fluctuation solvers based on finite element analysis, ray tracing, and geometry with simplified environment.

### Fluctuation Solver Based on Finite Element Analysis (Fluctuation Physics Simulation)

This algorithm divides the space to be calculated into densely arranged cubes, called “voxels” (similar to the concept of pixels, but pixel is an extremely small area unit on a two-dimensional plane, while voxel is an extremely small volume unit in three-dimensional space). ProjectAcoustics from Microsoft uses this algorithmic idea. The basic process of the algorithm is as follows:
1. In a virtual scene, excite one pulse from within a voxel at the location of a sound source;
2. In the next time segment, calculate pulses of all adjacent voxels of this voxel according to the voxel size and whether the adjacent voxels contain the scene shape;
3. Repeat step 2 many times to calculate the sound wave field in the scene. The more repetitions, the more accurate the sound wave field is calculated;
4. Get the listener's position, and the array of all historical amplitudes on the voxel at that position is the impulse response from the sound source to the listener's position under the current scene;
5. Repeat steps 1-4 for all sound sources in the scene. The room acoustics simulation algorithm based on a waveform solver has the following advantages:
1. The temporal and spatial precisions are very high, as long as the voxels are given small enough and the time slice length is short enough.
2. It can be adapted to scenes of any shape and material.

Meanwhile, this algorithm has the following shortcomings:
1. The amount of calculation is huge. The amount of computation is inversely proportional to the cube of the voxel size and directly proportional to the time slice length. In real application scenarios, it is almost impossible for us to calculate fluctuation physics in real time while ensuring reasonable time and space precisions.
2. Because of the above defects, when it is necessary to render room acoustic phenomena in real time, software developers will choose to pre-render impulse responses between a large number of sound sources and listeners under different position combinations, parameterize them, and switch rendering parameters in real time according to the different positions of the listeners and sound sources when calculating in real time. But this will require a powerful computing device (Microsoft uses its own Azure cloud) for pre-rendering calculations, and additional storage space to store a large number of parameters.
3. As mentioned above, this method cannot correctly reflect changes in acoustic properties of a scene when the scene has some changes that were not taken into account when pre-rendering, because corresponding rendering parameters are not saved.

### Ray Tracing

The core idea of this algorithm is to find as many sound propagation paths from a sound source to a listener as possible, so as to obtain the energy direction, delay, and filtering properties that the path will bring. Such an algorithm is the core of room acoustics simulation systems from Oculus and Wwise.

The algorithm for finding the propagation path from the sound source to the listener can be simply summarized in the following steps:
1. Taking the listener's position as the origin, radiate several rays uniformly distributed on the sphere into space; For each ray:
   a. If the vertical distance between the ray and a certain sound source is less than a preset value, the current path will be recorded as an effective path of the sound source and saved;
   b. When the ray intersects with the scene, the direction of the ray will be changed according to preset material information of the triangle where the intersection point is located, and the ray will continue to be emitted in the scene;
   c. Repeat steps a and b until the number of reflections of the ray reaches a preset maximum reflection depth, then return to step 2 and perform steps a to c for the initial direction of the next ray;
At this point, each sound source has recorded some path information. We then use this information to calculate the energy direction, delay, and filtering properties of each path for each sound source. We collectively refer to this information as a spatial impulse response between a sound source and a listener.

Finally, as long as we auralize the spatial impulse response of each sound source, we can simulate very realistic sound source orientation and distance, as well as the characteristics of the sound source and the environment where the listener is located. There are two methods for spatial impulse response autalizion:
1. Encode the spatial impulse response into an ambisonics domain, then generate a binaural room impulse response (BRIR) with the ambisonics domain, and finally, convolve the original signal of the sound source with the BRIR to obtain the spatial audio with room reflections and reverberation.
2. Encode the original signal of the sound source into the ambisonics domain using information of the spatial impulse response, and then render the ambisonics to binaural output.

The environmental acoustics simulation algorithm based on ray tracing has the following advantages:
1. Compared with fluctuation physics simulation, the amount of calculation is much lower and no pre-rendering is required;
2. Can adapt to dynamically changing scenes (opening doors, material changes, roof being blown off, etc.);
3. Can adapt to any shape of scene.

Meanwhile, such an algorithm also has the following disadvantages:
1. The precision of the algorithm is extremely dependent on the amount of sampling in the initial direction of the ray, that is, more rays; however, since the complexity of the ray tracing algorithm is O(n log (n)), more rays will inevitably lead to an explosive increase in the amount of calculation;
2. Whether it is BRIR convolution or encoding the original signal into ambisonics, the amount of calculation is considerable. As the number of sound sources in the scene increases, the amount of calculation will increase linearly. This is not very friendly to mobile devices with limited computing power.
   Geometry with Simplified Environment

The idea of the last algorithm is to try to find an approximate, but much simpler geometry and surface material after given the geometry and surface material of current scene, thereby greatly reducing the amount of calculation of environmental acoustic simulation. Such practices are not very common, some examples are Resonance engine from Google:
1. In the pre-rendering stage, the room shape of a cube is estimated;
2. Using geometric properties of the cube and assuming that the sound source and the listener are at the same position, calculate the direct sound and early reflections between the sound source and the listener in the scene quickly by using a look-up table method;
3. In the pre-rendering stage, calculate the duration of late reverberation in the current scene using an empirical equation for a cubic room reverberation duration, thereby controlling an artificial reverberation to simulate the late reverberation effect of the scene.

Such an algorithm has the following advantages:
1. With very little amount of calculation;
2. In theory, infinite reverberation duration can be simulated without additional CPU and memory overhead.

However, such an algorithm, at least with currently disclosed methods, has following disadvantages:
1. The approximate shape of a scene is calculated in the pre-rendering stage and cannot adapt to dynamically changing scenes (opening doors, material changes, roofs being blown off, etc.);
2. It is assumed that the sound source and the listener are always in the same position, which is extremely unrealistic;
3. It is assumed that all scene shapes can be approximated as cubes with three sides parallel to the world coordinates, and many real scenes (narrow corridors, sloping stairwells, old and crooked containers, etc.) cannot be correctly rendered.

In conclusion: such an algorithm greatly sacrifices rendering quality in exchange for ultimate rendering speed. One of the core problems is the overly rough simplification of the scene shape; this is exactly the problem that the present disclosure intends to solve.

The technical solutions in the embodiments of the present disclosure will be clearly and completely described below with reference to the accompanying drawings in the embodiments of the present disclosure. Obviously, the described embodiments are only some of the embodiments of the present disclosure, rather than all of the embodiments. The following description of at least one exemplary embodiment is merely illustrative in nature and is in no way intended to limit the disclosure, its application or uses. Based on the embodiments in this disclosure, all other embodiments obtained by those of ordinary skill in the art without making creative efforts fall within the scope of protection of this disclosure.

The relative arrangement of components and steps, numerical expressions, and numerical values set forth in these embodiments do not limit the scope of the disclosure unless otherwise specifically stated. At the same time, it should be understood that, for convenience of description, the sizes of various parts shown in the drawings are not drawn according to actual scale. Techniques, methods and devices known to those of ordinary skill in the relevant art may not be discussed in detail, but where appropriate, such techniques, methods and devices should be considered part of the authorized specification. In all examples shown and discussed herein, any specific values are to be construed as illustrative only and not as limiting. Accordingly, other examples of the exemplary embodiments may have different values. It should be noted that similar reference numerals and letters refer to similar items in the attached drawings, so that once one item is defined in one drawings, it does not require further discussion in subsequent drawings.

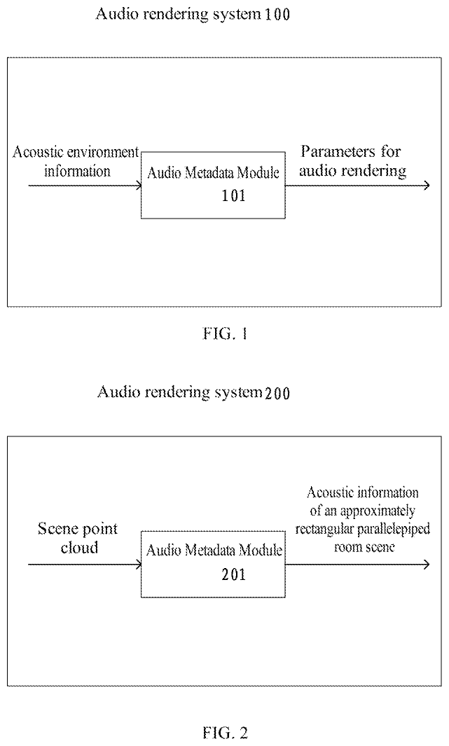

FIG. 1 is a schematic diagram of an audio rendering system according to some embodiments of the present disclosure. As shown in FIG. 1, the audio rendering system 100 includes an audio metadata module 101, which is configured to obtain acoustic environment information; the audio metadata module 101 is configured to set parameters for audio rendering according to the acoustic environment information, the parameters for audio rendering including acoustic information of an approximately rectangular parallelepiped room scene, an audio signal being rendered according to the parameters for audio rendering. In some embodiments of the present disclosure, the rectangular parallelepiped room includes a cube room.

FIG. 2 is a schematic diagram of an audio rendering system according to some embodiments of the present disclosure. As shown in FIG. 2, the audio metadata module 201 obtains scene point clouds consisting of a plurality of scene points collected from a virtual scene. The audio metadata module 201 is configured to estimate acoustic information of an approximately rectangular parallelepiped room scene according to the collected scene point clouds. In some embodiments of the present disclosure, the acoustic information of the approximately rectangular parallelepiped room scene includes at least one of: size, center coordinates, orientation, and approximate acoustic properties of the wall material. In some embodiments of the present disclosure, collecting scene point clouds consisting of a plurality of scene points from a virtual scene includes setting N intersection points of N rays emitted in various directions with a listener as the origin and the virtual scene as scene points.

FIG. 3 is a block diagram of steps for an audio rendering system to set parameters for audio rendering according to some embodiments of the present disclosure. In step S301, scene point clouds consisting of a plurality of scene points in a virtual scene is collected. In step S302, a minimum bounding box is determined according to the collected scene point clouds. In step S303, the estimated size and center coordinates of the rectangular parallelepiped room scene are determined according to the minimum bounding box.

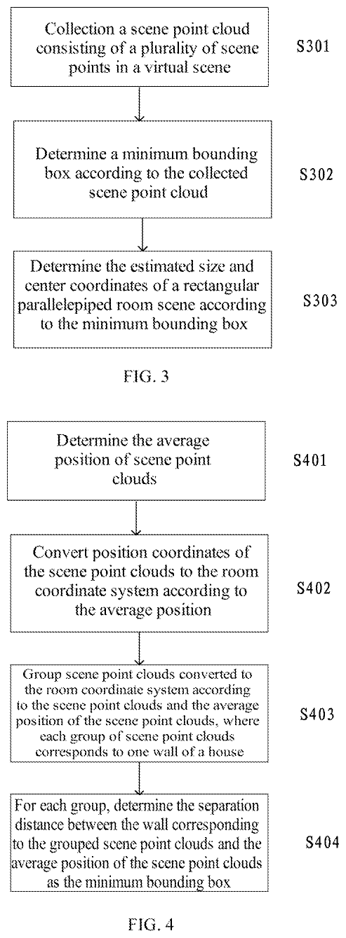

FIG. 4 is a block diagram of steps for an audio rendering system to set parameters for audio rendering according to some embodiments of the present disclosure. FIG. 4 shows one implementation of determining the minimum bounding box according to the collected scene point clouds in S302 in FIG. 3. The embodiment shown in FIG. 4 is only one implementation of determining the minimum bounding box implemented by the present disclosure, and the present disclosure is not limited to this implementation. In step S401, the average position of the scene point clouds is determined. In step S402, position coordinates of the scene point clouds are converted to the room coordinate system according to the average position. In S403, scene point clouds converted to the room coordinate system are grouped according to the scene point clouds and the average position of the scene point clouds, where each group of scene point clouds corresponds to one wall of a house. In some embodiments of the present disclosure, a wall refers to any one of a wall, a floor, and a ceiling of an approximately rectangular parallelepiped room. In step S404, for each group, the separation distance between the wall corresponding to the grouped scene point clouds and the average position of the scene point clouds is determined as the minimum bounding box.

In some embodiments of the present disclosure, scene point clouds P consisting of a plurality of scene points in a virtual scene is collected. In some embodiments of the present disclosure, each point cloud P contains the position of the point, a normal vector, and material information of a mesh where the point is located. In some embodiments of the present disclosure, the above scene point clouds can be formed by taking a listener as the origin, emitting N rays uniformly in all directions, and taking N intersection points between the rays and the scene as point clouds. In some embodiments of the present disclosure, the value of N is dynamically determined by comprehensively considering the stability, real-time performance and total calculation amount of room acoustic information estimation. The average position p̅ of the scene point clouds is calculated. In some embodiments of the present disclosure, according to the distance from scene points to p̅ in the scene point cloud, points with the first x % and the last y % of the distance length are eliminated, where x and y can be predetermined values. The position coordinates of the scene point clouds are converted to the room coordinate system. In some embodiments of the present disclosure, the conversion is performed based on the average position p̅ of the scene point clouds. The scene point clouds converted to the room coordinate system are grouped according to the scene point clouds and the average position of the scene point clouds, where each group of scene point clouds corresponds to one wall of a house. For each group, the separation distance between the wall corresponding to the grouped scene point clouds and the average position p̅ of the scene point clouds is determined to be the minimum bounding box. After the minimum bounding box is determined, return to step S303 in FIG. 3 to determine the estimated size and center coordinates of the rectangular parallelepiped room scene according to the minimum bounding box.

In some embodiments of the present disclosure, for each group of point clouds of the collected scene point clouds P, approximate acoustic properties of the material of the wall referred to by the group are calculated. If the group is not empty, the current material settings of the group are: the absorbance is set to the average absorptance of all points in the group; the scattering rate is set to the average scattering rate of all points in the group; and the transmittance is set to the average transmittance of all points in the group. If the group is empty, the current material settings of the group are: the absorbance is set to 100% absorption; the scattering rate is set to 0% scattering; and the transmittance is set to 100% transmission.

In some embodiments of the present disclosure, an approximately rectangular parallelepiped room orientation is estimated for the collected scene point clouds P. For each group of point clouds, calculate the average normal vector n̅(w); calculate the normal vector angle with the wall w, including horizontal angle θ(w) and pitch angle φ(w); calculate the global horizontal angle and pitch angle of the rectangular parallelepiped room orientation:

$$\begin{matrix}θ = \frac{{\sum }_{0}^{5} θ ( w )}{6} \\ φ = \frac{{\sum }_{0}^{5} φ ( w )}{6}\end{matrix} \qquad Equation 1$$

FIG. 5 is a block diagram of steps for an audio rendering system to set parameters for audio rendering according to other embodiments of the present disclosure. FIG. 5 is a further embodiment on the basis of FIG. 3. In step S501, a scene point cloud consisting of a plurality of scene points in a virtual scene of current frame is collected. In step S502, a minimum bounding box is determined according to the scene point cloud collected in the current frame and scene point clouds collected in previous frames. In step S503, the size and center coordinates of the rectangular parallelepiped room scene estimated in the current frame are determined according to the minimum bounding box. In some embodiments of the present disclosure, the step process of FIG. 5 is executed frame by frame to dynamically estimate acoustic information of the approximately rectangular parallelepiped room scene.

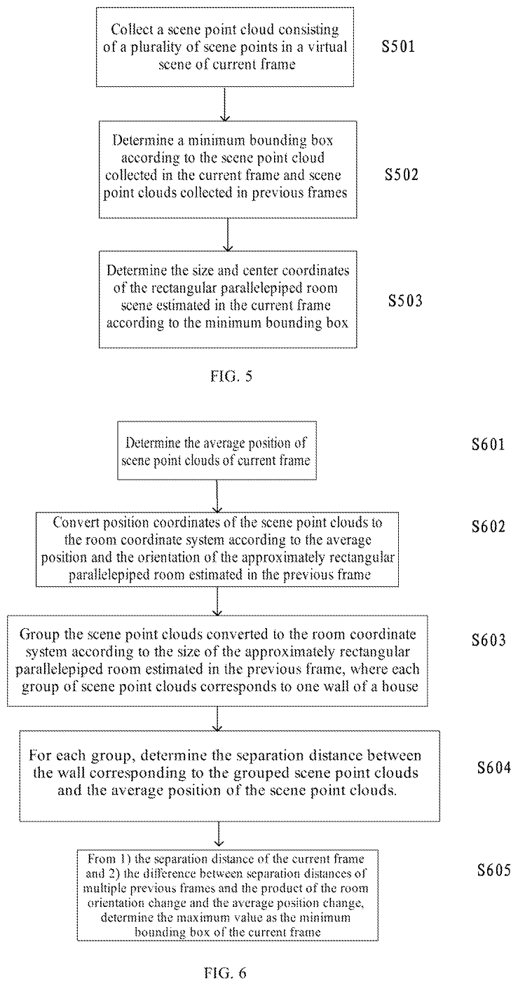

FIG. 6 is a block diagram of steps for an audio rendering system to set parameters for audio rendering according to other embodiments of the present disclosure. FIG. 6 shows one specific embodiment of implementing S502 in FIG. 5 to determine the minimum bounding box according to the scene point clouds collected in the current frame and scene point clouds collected in previous frames. The embodiment shown in FIG. 6 is only one implementation of determining the minimum bounding box implemented by the present disclosure, and the present disclosure is not limited to this implementation. In step S601, the average position of the collected scene point clouds of current frame is determined. In step S602, position coordinates of the scene point clouds are converted to the room coordinate system according to the average position and the orientation of the approximately rectangular parallelepiped room estimated in the previous frame. In step S603, the scene point clouds converted to the room coordinate system are grouped according to the size of the approximately rectangular parallelepiped room estimated in the previous frame, where each group of scene point clouds corresponds to one wall of a house. In step S604, for each group, the separation distance between the wall corresponding to the grouped scene point clouds and the average position of the scene point clouds is determined. In step S605, from 1) the separation distance of the current frame and 2) the difference between separation distances of multiple previous frames and the product of the room orientation change and the average position change, the maximum value is determined as the minimum bounding box of the current frame. After the minimum bounding box is determined, return to step S503 in FIG. 5 to determine the estimated size and center coordinates of the rectangular parallelepiped room scene according to the minimum bounding box.

FIG. 7 shows a schematic diagram of an estimated approximately rectangular parallelepiped room scene. The following describes in detail some embodiment algorithms for estimating acoustic information of an approximately rectangular parallelepiped room scene, in which all information related to geometric properties (position, angle, etc.) are world coordinates. As an example, all length units below are meter, but other distance units can be used as needed. The embodiment shown in FIG. 7 is only one implementation of an estimated approximately rectangular parallelepiped room scene implemented by the present disclosure, and the present disclosure is not limited to this implementation.

Embodiments of determining a minimum bounding box according to scene point clouds collected in current frame and scene point clouds collected in previous frames will be described in detail below with reference to FIG. 6.

First, in some embodiments of the present disclosure, initial conditions and variable definitions are determined. Please see the following for details:
Define the center position of a rectangular parallelepiped room c=(0, 0, 0);
Define both the horizontal angle θ and pitch angle φ of the rectangular parallelepiped room to be 0; define the size of the rectangular parallelepiped room d=(1, 1, 1);
Define the wall/floor/ceiling materials of the rectangular parallelepiped room:

$$\begin{matrix}i . Absorptance = 100 \% ; \\ ii . Scattering rate = 0 \% ; \\ iii . Transmittance = 100 \%\end{matrix}$$

The number of historical records used to estimate the distance from the wall to the center h(w)=1, where w is a wall subscript, which is six integers, representing six walls of the cuboid. For convenience of expression, it takes the value from 0 to 5 herein. The corresponding relationship between walls and subscripts is as follows:

CHART 1

| w | 0 | 1 | 2 | 3 | 4 | 5 |
|---|---|---|---|---|---|---|
| normal vector | (−1, 0, 0) | (1, 0, 0) | (0, −1, 0) | (0, 1, 0) | (0, 0, −1) | (0, 0, 1) |
| direction of | | | | | | |
| the wall | | | | | | |
| (rectangular | | | | | | |
| parallelepiped | | | | | | |
| room | | | | | | |
| coordinate | | | | | | |
| system) | | | | | | |

An approximation process for dynamically estimating an approximately rectangular parallelepiped room scene is performed for each frame. One implementation of the approximation process for dynamically estimating an approximately rectangular parallelepiped room scene is described below.

In some embodiments of the present disclosure, as shown in FIG. 7, scene point clouds P consisting of a plurality of scene points in a virtual scene of current frame is collected. In some embodiments of the present disclosure, each point cloud P contains the position of the point, a normal vector, and material information of a mesh where the point is located. In some embodiments of the present disclosure, the above scene point clouds can be formed by taking a listener as the origin, emitting N rays uniformly in all directions, and taking N intersection points between the rays and the scene as point clouds. In some embodiments of the present disclosure, the value of N is dynamically determined by comprehensively considering the stability, real-time performance and total calculation amount of room acoustic information estimation.

Calculate the average position p̅ of the scene point clouds P. In some embodiments of the present disclosure, according to the distance from scene points to p in the scene point cloud, points with the first x % and the last y % of the distance length are eliminated, where x and y can be predetermined values, or they can be inputted as a parameter at the start of the approximation in each frame.

Convert position coordinates of the scene point clouds to the room coordinate system. In some embodiments of the present disclosure, the conversion is performed according to p̅ and the horizontal angle and pitch angle of the rectangular parallelepiped room estimated in the previous frame.

Divide the point clouds converted to the room coordinate system into 6 groups according to the estimated size d of the room in the previous frame, each group corresponding to one wall/floor/ceiling. For each group of point clouds, calculate the distance wcd (w) from the wall referred to by the group to p̅, where w is a wall subscript. In some embodiments of the present disclosure, if the group is not empty, for each point in the group: calculate the normal vector projected from the distance from a point in the room coordinate system to the coordinate origin to the wall referred to by the group; take the maximum value of all projection lengths of current group as the distance wcd from the wall referred to by the current group of the current frame to the center of the rectangular parallelepiped. If the group is empty, then for the wall referred to by the current group of the current frame: wall w is missing, flag is set to true, and h (w) used by wall w is 1, i.e., h(w)=1.

According to the p̅ of the past h(w) frames, wcd(w) and the rectangular parallelepiped room orientation information rot, the minimum bounding box mcd(w) that can satisfy all historical records is calculated. The solution for solving the minimum bounding box mcd(w) according to some embodiments of the present disclosure is given in Equation 1, where t represents the t-th frame in the future starting from the current frame; −t represents the t-th frame in the past starting from the current frame;

$${max}_{t = 0 : ( h ( w ) - 1 )}$$

represents the maximum value from frame t=0 to frame t=h (w)−1; while rot(0)*rot(−t)⁻¹ represents the change in room orientation between the current frame (i.e., t=0) and the past t-th frame; p̅(0)−p̅(−t) represents the change in the average position of scene point clouds between the current frame (i.e., t=0) and the past t-th frame; h(w) represents the number of historical records used to estimate the distance from wall w to the center, and mcd(w) represents the distance from each wall w to the current p̅ in the minimum bounding box to be solved.

In some embodiments of the present disclosure, p̅ is written to one queue p̅(t) with length hₘₐₓ and wcd(w) is written to another queue wcd(t)(w) with length hₘₐₓ. According to p̅ and wcd(w) history of the past h(w) frames, the minimum bounding box mcd(w) that can satisfy all history records is calculated. Specifically, from the difference wcd(−t)(w)−(rot(0)*rot(−t)−1)+(p̅(0)−p̅(−t)) (where t=0: (h (w)−1)) between separation distance wcd(0)(w) of the current frame and separation distances of multiple previous frames and the product of the room orientation change and the average position change, the maximum value is determined as the minimum bounding box mcd(w) of the current frame. mcd(w) represents the distance from each wall to the current p̅ in the minimum bounding box to be solved. Specifically, for each group of point clouds w:

$$m c d ( w ) = {max}_{t = 0 : ( h ( w ) - 1 )} ( w c d ( - t ) ( w ) - ( r o t ( 0 ) * r o {t ( - t )}^{- 1} ) * ( \overline{p} ( 0 ) - \overline{p} ( - t ) ) ) \qquad Equation 2$$

Wherein, rot(h) is a quaternion queue with length hₘₐₓ, which stores rectangular parallelepiped room orientation information estimated in past hₘₐₓ frames.

$$h ( w ) = max ( h ( w ) + 1 , {h}_{m ax} ) \qquad Equation 3$$

According to the minimum bounding box, it is determined the size d and room center coordinates c of the rectangular parallelepiped room scene estimated in the current frame.

$$d = \frac{\{ \begin{matrix}mcd ( 0 ) + m c d ( 1 ) & mcd ( 2 ) + m c d ( 3 ) & mcd ( 4 ) + m c d ( 5 )\end{matrix} \}}{2} \qquad Equation 4$$

$$c = \overline{p} + \frac{\{ \begin{matrix}mcd ( 0 ) - m c d ( 1 ) & mcd ( 2 ) - m c d ( 3 ) & mcd ( 4 ) - m c d ( 5 )\end{matrix} \}}{2}$$

Although this disclosure describes dynamically estimating acoustic information of an approximately rectangular parallelepiped room scene according to the current frame and multiple previous frames in conjunction with FIG. 6 and Equations 1-4, it can be understood that Equations 1-4 are also applicable to embodiments in which acoustic information of an approximately rectangular parallelepiped room is determined according to scene point clouds collected in this frame in some cases, that is, t=0.

In some embodiments of the present disclosure, unlike the unrealistic situation in the related art where it is assumed that the listener and the estimated virtual room are always at the same location, the present disclosure does not bind the listener to the estimated virtual room, but assumes that the listener can move freely in the scene. Since the location of the listener may be different in each frame, when N rays are emitted uniformly to the surrounding walls with the listener as the origin at different frames, the number and density of intersections of the N rays with surrounding walls (i.e., walls, floors, and ceilings) may not be the same at each wall. For example, when a listener is close to a certain wall, the rays emitted from the listener will have more intersections with the adjacent wall, while intersections with other walls will decrease accordingly depending on the distance between the wall and the listener. Therefore, when estimating house acoustic information (for example, the size of the room, orientation, average position of the scene point clouds) of an approximately rectangular parallelepiped room scene, the weight of the adjacent wall will be greater. While this wall with a larger weight will play a more decisive role in the subsequent calculation of the size of the room, the orientation of the room and the average position of the scene point clouds. For example, the average position of the scene point clouds will be closer to the wall with a larger weight. In this way, at different frames, due to possible differences in the listener's location, the estimated the size of the room, the orientation of the room, and the average position of the scene point clouds will also be different. Therefore, in order to reduce the impact caused by different listener locations at different frames, when calculating the minimum bounding box of the current frame, from 1) the separation distance of the current frame wcd(w) and 2) the difference between wcd(w) of multiple previous frames and the product of the room orientation change and the average position change, the maximum value is determined as the minimum bounding box of the current frame, that is, by subtracting the product of the room orientation change and the average position change to try to avoid the impact of different listener locations at different frames. According to the determined minimum bounding box, the size of the room and the coordinates of the room center of the current frame are further determined.

In some embodiments of the present disclosure, the minimum bounding box is determined according to scene point clouds collected in the current frame and scene point clouds collected in the past multiple frames, and at the same time, changes in the room orientation and the average position of the scene point clouds due to different listener locations between the current frame and each of the past frames are also considered, so as to avoid as much as possible differences in the estimated room acoustic information (for example, room orientation and the average position of scene point clouds) due to different listener locations in different frames, and thus to lower as much as possible the impact on the estimation of room acoustic information due to different listener locations at different frames, and at the same time to be able to adapt to dynamically changing scenes (opening doors, material changes, roof being blown off, etc.). In some embodiments of the present disclosure, the number of multiplexed past frames is dynamically determined by comprehensively considering room acoustic information estimation characteristics, such as stability and real-time performance, so that while obtaining reliable estimation data, transient changes in the scene (for example, door opening, material change, roof being blown off, etc.) can also be reflected timely and effectively, for example, a larger number of previous frames are used to ensure the stability of the estimation, while a small number of previous frames are used to ensure the real-time performance of the estimation.

For each group of point clouds, the approximate acoustic properties of the material of the wall referred to by the group are calculated. In some embodiments of the present disclosure, if the group is not empty, the current material settings of the group are: the absorptance is set to the average absorptance of all points in the group; the scattering rate is set to the average scattering rate of all points in the group; and the transmittance is set to the average transmittance of all points in the group. If the group is empty, the current material settings of the group are: the absorptance is set to 100% absorption; the scattering rate is set to 0% scattering; and the transmittance is set to 100% transmission.

Estimate the orientation of an approximately rectangular parallelepiped room. In some embodiments of the present disclosure, the average normal vector n̅(w) is calculated for each group of point clouds; the angle between the normal vector and wall w is calculated, including the horizontal angle θ(w) and the pitch angle φ(w); and the global horizontal angle and pitch angle of the rectangular parallelepiped room orientation are calculated:

$$\begin{matrix}θ = \frac{{\sum }_{0}^{5} θ ( w )}{6} \\ φ = \frac{{\sum }_{0}^{5} φ ( w )}{6}\end{matrix} \qquad Equation 5$$

The global horizontal angle and pitch angle (θ, φ) are converted to quaternion representations rot, which is written to a queue rot(t) with length hₘₐₓ.

At this point, the approximation estimation process for each frame ends.

This disclosure progressively estimates an approximately rectangular parallelepiped model of a room in real time; estimates the room orientation through the normal vector of scene point clouds; and by reusing calculation results of the previous hₘₐₓ frames, reduces the number of scene sampling points required for each frame (i.e., the number N of rays emitted in all directions with the listener as the origin) greatly, thereby speeding up the calculation for each frame in the algorithm. By continuously running the approximation estimation process for each frame, the disclosed algorithm can estimate an increasingly accurate approximately rectangular parallelepiped room model, thereby being able to quickly render scene reflections and reverberation. The present disclosure can estimate the approximately rectangular parallelepiped model of a scene where the listener is located in real time, and obtain the position, size, and orientation of the model. This disclosure enables a room acoustics simulation algorithm based on approximately rectangular parallelepiped model estimation to maintain its extreme high computational efficiency compared to other algorithms (fluctuation physics simulation, ray tracing) without sacrificing interactivity, requiring no pre-rendering, and supporting variable scenes. This algorithm can run at a much lower frequency than other audio and rendering threads, without affecting the update speed of the direction sense of direct sound and early reflected sound.

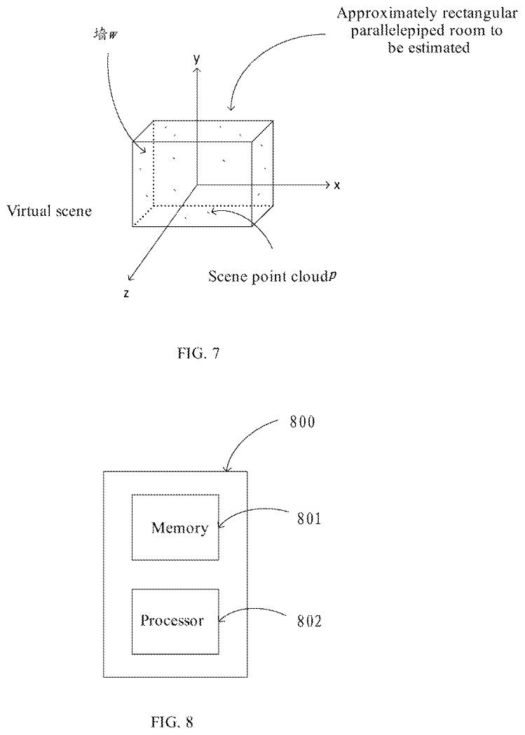

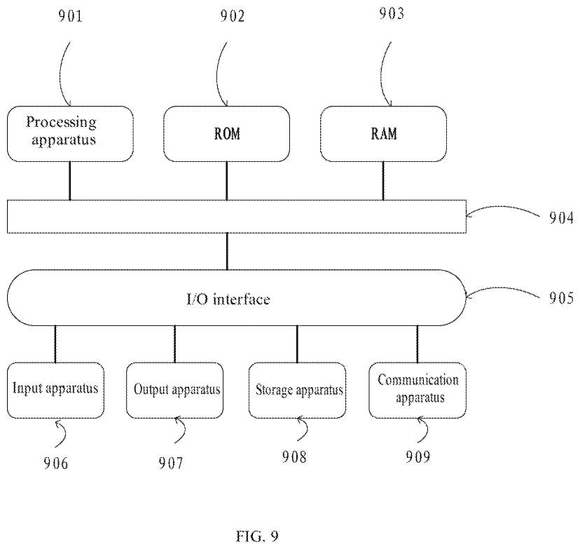

FIG. 8 shows a schematic diagram of an electronic device according to some embodiments of the present disclosure.

As shown in FIG. 8, an electronic device 800 includes: a memory 801 and a processor 802 coupled to the memory 801. The processor 802 is configured to execute the method described in any one or some embodiments of the present disclosure based on instructions stored in the memory 801. Wherein, the memory 801 may include, for example, a system memory, a fixed non-volatile storage medium, etc. The system memory stores, for example, operating systems, application programs, boot loaders, databases, and other programs.

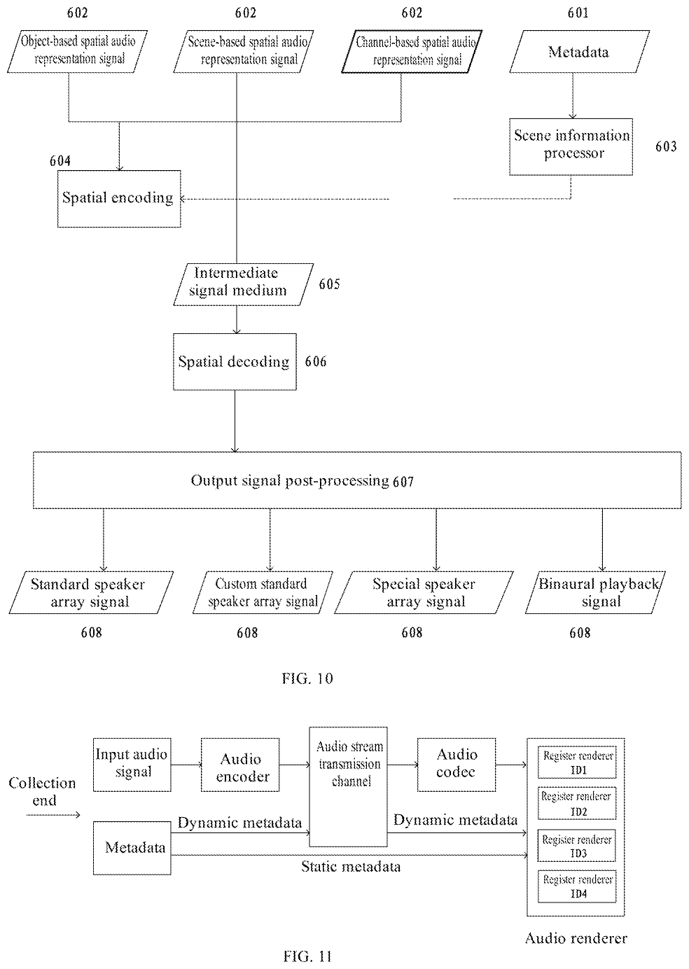

FIG. 9 shows a schematic diagram of the structure of an electronic device according to some embodiments of the present disclosure. The electronic device in the embodiments of the present disclosure may include, but not limited to, a mobile terminal such as a mobile phone, a laptop, a digital broadcast receiver, a PDA (Personal Digital Assistant), a PAD (Tablet), a PMP (Portable Multimedia Player), a vehicle-mounted terminal (such as a car navigation terminal), etc., and a fixed terminal such as a digital TV, a desktop computer, etc. The electronic device shown in FIG. 9 is only an example and should not impose any limitations on the functions and scope of use of the embodiments of the present disclosure. As shown in FIG. 9, the electronic device may include a processing apparatus (for example, a central processing unit, a graphics processor, etc.) 901, which may perform various appropriate actions and processes according to a program stored in a read-only memory (ROM) 902 or loaded from a storage apparatus 908 into a random-access memory (RAM) 903. In the RAM 903, various programs and data required for operations of the electronic device are also stored. The processing apparatus 901, the ROM 902 and the RAM 903 are connected to each other via a bus 904. An input/output (I/O) interface 905 is also connected to the bus 904.

Generally, the following apparatus may be connected to the I/O interface 905: an input apparatus 906 including, for example, a touch screen, a touch pad, a keyboard, a mouse, an image sensor, a microphone, an accelerometer, a gyroscope, etc.; an output apparatus 907 including, for example, a liquid crystal display (LCD), a speaker, a vibrator, etc.; a storage apparatus 908 including, for example, a tape, a hard disk, etc.; and a communication apparatus 909. The communication apparatus 909 may allow the electronic device to communicate wirelessly or with wire with other devices to exchange data. Although FIG. 9 illustrates an electronic device having various apparatus, it should be understood that implementation or availability of all illustrated apparatus is not required. More or fewer apparatus may alternatively be implemented or provided.

FIG. 10 is a schematic diagram of an audio renderer according to some embodiments of the present disclosure. For the purpose of illustration, FIG. 10 shows a renderer based on binaural output, but the present disclosure is not limited to the renderer based on binaural output, and is also applicable to renderers based on other methods. Audio renderer 600 shown in FIG. 10 receives metadata 601 and spatial audio representation signal 602. The spatial audio representation signal 602 includes an object-based spatial audio representation signal, a scene-based spatial audio representation signal, and a channel-based spatial audio representation signal. Metadata 601 includes parameters for audio rendering, for example, audio payload information indicating whether the input form of the audio payload is mono-channel, dual-channel, multi-channel, Object, or sound field HOA, location information indicating the location of dynamic sound source and listener, and acoustic environment information indicating the rendered acoustic environment (such as room shape, size, orientation, wall material, etc.). The parameters for audio rendering direct the spatial encoding module 604 to perform signal processing on the spatial audio representation signal 602. According to some embodiments of the present disclosure, metadata 601 is processed by an environmental acoustics simulation algorithm via a scene information processor 603 to determine the parameters for audio rendering. According to some embodiments of the present disclosure, the environmental acoustics simulation algorithm includes an algorithm for dynamically estimating acoustic information of an approximately rectangular parallelepiped room scene. The processed signal is decoded by spatial decoding module 606 via an intermediate signal medium. The decoded data is processed by the output signal post-processing module 607 to output a signal 608, which includes a standard speaker array signal, a custom speaker array signal, a special speaker array signal, and a binaural playback signal.

FIG. 11 is a schematic diagram of a virtual reality audio content expression framework according to some embodiments of the present disclosure. Virtual reality audio content expression broadly involves metadata, audio codecs, and audio renderers. In some embodiments of the present disclosure, metadata, renderers, and codecs are logically separated from each other. In some embodiments of the present disclosure, when used for local storage and production, only the renderer is required to parse metadata, and the audio encoding and decoding process is not involved; when used for transmission (for example, live broadcast or two-way communication), it is necessary to define a transmission format of metadata+audio stream. As shown in the schematic diagram of a virtual reality audio content expression framework shown in FIG. 11, in some embodiments of the present disclosure, at the collection end, the input audio signal includes, for example, channel, object, hoa or their mixed form, and metadata information is generated according to the metadata definition. Dynamic metadata can be transmitted along with the audio stream, and the specific encapsulation format is defined according to the type of transmission protocol adopted by the system layer; static metadata is transmitted separately. At the playback end, a renderer will render and output the decoded audio file according to the decoded metadata. Metadata and audio codec are logically independent of each other, and the decoder and renderer are decoupled therebetween. The renderer adopts a registration regime. In some embodiments of the present disclosure, the renderer includes ID1 (binaural output-based renderer), ID2 (speaker output-based renderer), ID3 (other manner renderer), and ID 4 (other manner renderer), where each registered renderer supports the same set of metadata definitions. The renderer system first selects a registered renderer, and then each registered renderer reads metadata and audio files respectively. Input data for the renderer consists of registered renderer labels as well as metadata and audio data. In some embodiments of the present disclosure, the metadata and audio data constitute the BW64 file format. In some embodiments of the present disclosure, metadata is mainly implemented using Extensible Markup Language XML encoding, and metadata in XML format may be included in “axml” or “bxml” blocks of the BW64 format audio file for transmission. The “audio package format identifier”, “audio track format identifier” and “audio track unique identifier” in the generated metadata will be provided to “chna” blocks of the BW64 file to link the metadata with the actual audio track. Metadata basic elements (audioformatExtended) include: audio program (audioProgramme), audio content (audioContent), audio object (audioObject), audio package format (audioPackFormat), audio channel format (audioChannelFormat), audio stream format (audioStreamFormat), audio track Format (audioTrackFormat), audio track unique identifier (audioTrackUID), audio block format (audioBlockFormat).

According to the embodiments of the present disclosure, the processes described above with reference to flowcharts may be implemented as a computer software program. For example, embodiments of the present disclosure include a computer program product including a computer program carried on a computer-readable medium, the computer program containing program code for performing the method illustrated in the flowchart. In such embodiments, the computer program may be downloaded and installed from the network via the communication apparatus 909, or installed from the storage device 408, or installed from the ROM 402. When the computer program is executed by the processing apparatus 401, the above functions defined in the method of the embodiment of the present disclosure are performed.

In some embodiments, there is also provided a chip, comprising: at least one processor and an interface, the interface being used to provide computer execution instructions to the at least one processor, and the at least one processor is used to execute computer execution instructions to implement the reverberation duration estimation method or the audio signal rendering method in any of the above embodiments.

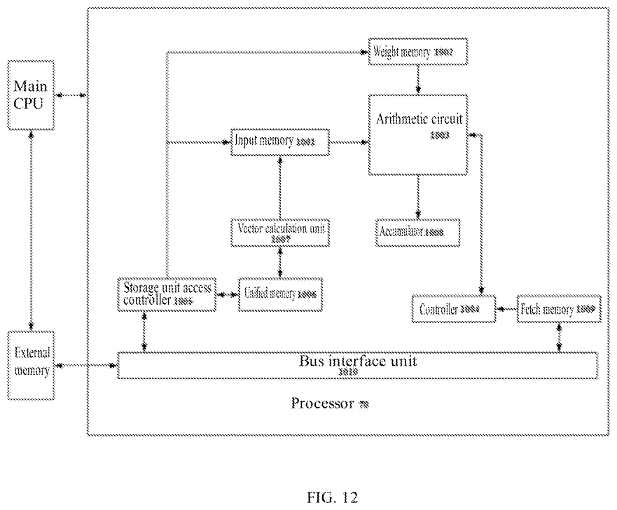

FIG. 12 shows a schematic diagram of a chip capable of implementing some embodiments in accordance with the present disclosure. As shown in FIG. 12, the processor 70 of the chip is mounted on a main CPU (Host CPU) as a co-processor, and is allocated tasks by the Host CPU. The core part of the processor 70 is an arithmetic circuit, and the controller 1004 controls the arithmetic circuit 1003 to extract data in the memory (weight memory or input memory) and conduct operations.

In some embodiments, the arithmetic circuit 1003 internally includes multiple processing Engines (PEs). In some embodiments, the arithmetic circuit 1003 is a two-dimensional systolic array. The arithmetic circuit 1003 may also be a one-dimensional systolic array or other electronic circuit capable of performing mathematical operations such as multiplication and addition. In some embodiments, the arithmetic circuit 1003 is a general-purpose matrix processor.

For example, assume there is an input matrix A, a weight matrix B, and an output matrix C. The arithmetic circuit obtains data corresponding to matrix B from the weight memory 1002 and caches it on each PE in the arithmetic circuit. The arithmetic circuit takes the matrix A data from the input memory 1001 and performs matrix operation with the matrix B, and obtains partial result or final result of the matrix, and stores the result in an accumulator 708.

A vector calculation unit 1007 can further process the output of the arithmetic circuit, such as vector multiplication, vector addition, exponential operation, logarithmic operation, size comparison, etc.

In some embodiments, the vector calculation unit 1007 can store the processed output vector to a unified buffer 1006. For example, the vector calculation unit 1007 may apply a nonlinear function to the output of the arithmetic circuit 1003, such as a vector of accumulated values, to generate activation values. In some embodiments, the vector calculation unit 1007 generates normalized values, merged values, or both. In some embodiments, the processed output vector can be used as an activation input to the arithmetic circuit 1003, for example for use in a subsequent layer in a neural network.

The unified memory 1006 is used to store input data and output data.

A Direct Memory Access Controller 1005 (DMAC) transfers input data in an external memory to the input memory 1001 and/or the unified memory 706, and stores weight data in the external memory into the weight memory 1002, and stores the data in the unified memory 1006 into the external memory.

A Bus Interface Unit (BIU) 1010 is used to realize interaction between the main CPU, DMAC and an instruction fetch memory 1009 via a bus.

The instruction fetch buffer 1009 connected to the controller 1004 is used to store instructions used by the controller 1004;

The controller 1004 is used to call instructions cached in the memory 1009 to control the working process of the computing accelerator.

Generally, the unified memory 1006, the input memory 1001, the weight memory 1002 and the instruction fetch memory 1009 are all On-Chip memories, and the external memory is a memory external to the NPU. The external memory can be a Double Data Rate Synchronous Dynamic Random Access Memory (DDR SDRAM), High Bandwidth Memory (HBM) or other readable and writable memory.

In some embodiments, there is also provided a computer program, comprising: instructions, which, when executed by a processor, cause the processor to perform the audio rendering method of any of the above embodiments, especially any processing in the audio signal rendering process.

Those skilled in the art will appreciate that the present disclosure may take the form of an entirely hardware embodiment, an entirely software embodiment, or embodiments that combine software and hardware aspects. When implemented using software, the above embodiments may be implemented in whole or in part in the form of a computer program product. A computer program product includes one or more computer instructions or computer programs. When computer instructions or computer programs are loaded or executed on a computer, processes or functions according to embodiments of the present application are generated in whole or in part. The computer may be a general-purpose computer, a special-purpose computer, a computer network, or other programmable apparatus. Furthermore, the present disclosure may take the form of a computer program product embodied on one or more computer-usable non-transitory storage media (including, but not limited to, disk memory, CD-ROM, optical memory, etc.) having computer-usable program code embodied therein.

Although some specific embodiments of the present disclosure have been described in detail through examples, those skilled in the art will understand that the above examples are for illustration only and are not intended to limit the scope of the disclosure. It should be understood by those skilled in the art that the above embodiments may be modified without departing from the scope and spirit of the present disclosure. The scope of the disclosure is defined by the appended claims.

I/We claim:

1. An audio rendering method, comprising:
obtaining audio metadata, the audio metadata including acoustic environment information;
setting parameters for audio rendering according to the acoustic environment information, the parameters for audio rendering including acoustic information of an approximately rectangular parallelepiped room scene; and
rendering an audio signal according to the parameters for audio rendering.

2. The audio rendering method according to claim 1, wherein the rectangular parallelepiped room comprises a cube room.

3. The audio rendering method according to claim 1, wherein the rendering an audio signal according to the parameters for audio rendering includes:
spatially encoding the audio signal based on the parameters for audio rendering, and
spatially decoding the spatially encoded audio signal to obtain a decoded audio-rendered audio signal.

4. The audio rendering method according to claim 1, wherein the audio signal includes a spatial audio signal.

5. The audio rendering method according to claim 1, wherein the spatial audio signal includes at least one of: an object-based spatial audio signal, a scene-based spatial audio signal, and a channel-based spatial audio signal.

6. The audio rendering method according to claim 1, wherein the acoustic information of the approximately rectangular parallelepiped room scene includes at least one of: the size of the room, center coordinates of the room, orientation, and approximate acoustic properties of the wall material.

7. The audio rendering method according to claim 1, wherein the acoustic environment information includes a scene point cloud consisting of a plurality of scene points collected from a virtual scene.

8. The audio rendering method according to claim 7, wherein collecting a scene point cloud consisting of a plurality of scene points from a virtual scene includes setting N intersection points of N rays emitted in various directions with a listener as the origin and the scene as scene points.

9. The audio rendering method according to claim 7, wherein estimating the acoustic information of the approximately rectangular parallelepiped room scene according to scene point clouds collected from the virtual scene includes:
determining a minimum bounding box according to the collected scene point clouds; and
determining the estimated size and center coordinates of the rectangular parallelepiped room scene according to the minimum bounding box.

10. The audio rendering method of claim 9, wherein determining the minimum bounding box includes:
determining the average position of the scene point clouds;
converting position coordinates of the scene point clouds to the room coordinate system according to the average position;
grouping the scene point clouds converted to the room coordinate system according to the scene point clouds and the average position of the scene point clouds, where one of the plurality of groups of scene point clouds corresponds to one wall of a house; and
for the one group, determining a separation distance between a wall corresponding to a grouped scene point cloud and the average position of the scene point clouds as the minimum bounding box.

11. The audio rendering method according to claim 10, wherein determining a separation distance between a wall corresponding to a grouped scene point cloud and the average position of the scene point clouds includes:
determining a projection length of the distance from a scene point cloud converted to the room coordinate system to the coordinate origin being projected to a wall referred to by the group; and
determining the maximum value of all projection lengths of the current group as the separation distance between the wall corresponding to the grouped scene point cloud and the average position.

12. The audio rendering method according to claim 10, wherein determining a separation distance between a wall corresponding to the grouped scene point cloud and the average position of the scene point clouds includes:
when the group is not empty, determining the separation distance; and
when the group is empty, determining that the wall is missing.

13. The audio rendering method according to claim 10, wherein the acoustic information of the approximately rectangular parallelepiped room scene includes approximate acoustic information of the room wall material, and estimating acoustic information of approximately rectangular parallelepiped room scene according to scene point clouds collected from a virtual scene further includes: determining approximate acoustic properties of the material of the wall referred to by the group according to the average absorptance, average scattering rate, and average transmittance of all point clouds in the group.

14. The audio rendering method according to claim 10, wherein the acoustic information of the approximately rectangular parallelepiped room scene includes the orientation of a room, and estimating acoustic information of the approximately rectangular parallelepiped room scene according to scene point clouds collected from a virtual scene further includes: determining the orientation of the approximately rectangular parallelepiped room according to the average normal vector of all point clouds in the group and the angle with the normal vector of the wall referred to by the group.

15. The audio rendering method according to claim 7, further comprising estimating acoustic information of the approximately rectangular parallelepiped room scene frame by frame according to scene point clouds collected from a virtual scene, including:
determining the minimum bounding box according to scene point clouds collected in the current frame and scene point clouds collected in previous frames; and
determining the size and center coordinates of the rectangular parallelepiped room scene estimated in the current frame according to the minimum bounding box.

16. The audio rendering method of claim 15, wherein the number of previous frames is determined according to properties estimated from acoustic information of the approximately rectangular parallelepiped room scene.

17. The audio rendering method according to claim 15, wherein determining the minimum bounding box according to scene point clouds collected in the current frame and scene point clouds collected in previous frames includes:
determining the average position of the scene point clouds of the current frame;
converting position coordinates of the scene point clouds to the room coordinate system according to the average position and the orientation of an approximately rectangular parallelepiped room estimated in the previous frame;
grouping the scene point clouds converted to the room coordinate system according to the size of the approximately rectangular parallelepiped room estimated in the previous frame, where each group of scene point clouds corresponds to one wall of a house;
for each group, determining a separation distance between a wall corresponding to a grouped scene point cloud and the average position of the scene point clouds; and
from 1) the separation distance of the current frame and 2) the difference between separation distances of multiple previous frames and the product of the room orientation change and the average position change, determining the maximum value as the minimum bounding box of the current frame.

18. The audio rendering method according to claim 7, wherein the minimum bounding box is determined from the collected scene point clouds based on the following equation:
$$m c d ( w ) = {max}_{t = 0 : ( h ( w ) - 1 )} ( w c d ( - t ) ( w ) - ( r o t ( 0 ) * r o {t ( - t )}^{- 1} ) * ( \overline{p} ( 0 ) - \overline{p} ( - t ) ) )$$
where mcd(w) represents the distance from each wall w to the current p̅ in the minimum bounding box to be solved; rot(t) represents orientation information of the approximately rectangular parallelepiped room in the t-th frame; and p̅(t) represents the average position of the scene point clouds in the t-th frame.

19. An electronic device, comprising:
a memory; and
a processor coupled to the memory, the processor being configured to perform an audio rendering method, the audio rendering method comprises:
obtaining audio metadata, the audio metadata including acoustic environment information;
setting parameters for audio rendering according to the acoustic environment information, the parameters for audio rendering including acoustic information of an approximately rectangular parallelepiped room scene; and
rendering an audio signal according to the parameters for audio rendering.

20. A non-transitory computer-readable storage medium having a computer program stored thereon, which, when executed by a processor, implements an audio rendering method, the audio rendering method comprises:
obtaining audio metadata, the audio metadata including acoustic environment information;
setting parameters for audio rendering according to the acoustic environment information, the parameters for audio rendering including acoustic information of an approximately rectangular parallelepiped room scene; and
rendering an audio signal according to the parameters for audio rendering.
